(19) United States
(12) Patent Application Publication
(10) Pub. No.: US 2008/0139235 A1
(43) Pub. Date: Jun. 12, 2008

(54) Method and Arrangement for Improved Outer Loop Power Control

(76) Inventors: Claes Tidestav, Balsla (SE); Magnus Almgren, Sollentuna (SE); Lei Wan, Beijing (CN)

Correspondence Address: NIXON & VANDERHYE, PC, 901 NORTH GLEBE ROAD, 11TH FLOOR, ARLINGTON, VA, 22203, US

(21) Appl. No.: 11/793,415

(22) PCT Filed: Dec. 22, 2004
(86) PCT No.: PCT/SE04/01989

§ 371 Date: Jun. 20, 2007

(51) Int. Cl. H04B 7/005

(52) U.S. Cl. 455/522; 455/67.11

(57) ABSTRACT

A method for improved outer loop power control in a communication system, comprising collecting (S1) quality measurements for a plurality of sub-block within a received coding block; mapping (S2′) the collected sub-block level quality measurements to a block level quality measure, and adjusting (S3′) the inner loop power control requirement based at least on a representation of the block level quality measure.

This application is the U.S. national phase of International Application No. PCT/SE2004/001989 filed 22 Dec. 2004 which designated the U.S., the entire content of each of which is hereby incorporated by reference.

### TECHNICAL FIELD

The present invention relates to communication systems in general, specifically to improved power control in interference limited communication systems.

### BACKGROUND

The Transmit Power Control (PC or TPC) functionality is crucial for interference limited cellular systems, such as WCDMA, GSM and cdma2000, where more high-powered mobiles interfere with weaker mobiles in the system. Power control adjusts the transmit power from a transmitter, e.g. mobile station, in order to maintain a certain quality at a receiver, e.g. a base station. This reduces the interference caused by the transmitter to other receivers. Also, the battery power for the mobile stations is conserved.

In systems utilizing Code Division Multiple Access (CDMA), known power control functionalities that operate on the Signal-to-Interference-Ratio (SIR) include Outer Loop Power Control (OLPC) and INner loop Power Control (INPC). The OLPC is responsible for compensating for channel or link variations by adjusting the SIR target for the INPC which is sensitive to the accuracy of instantaneous quality measurements. The OLPC is typically based on the block error indicator (BEI) checked by a Cyclic Redundancy Check (CRC),

The INPC subsequently compares the estimated SIR at the receiver with the SIR target and adjusts the transmitted power accordingly. If the estimated SIR is higher than the SIR target, a Transmit Power Control (TPC) command to decrease the transmit power is signaled to the transmitter and vice versa if the estimated SIR exceeds the SIR target.

The problem with OLPC, according to prior art, is that it is not suitable to use in cases where the BLER is an inaccurate measure of the quality. Also, the current OLPC has in many cases very slow convergence

Some attempts in prior art to provide improved outer loop power control has included adding a middle loop between the outer and the inner loop [2], [3] rather than actually improving the OLPC.

Therefore, there is a need for an improved OLPC which is faster and provides a better estimate of end user quality.

### SUMMARY

An object of the present invention is to improve outer loop power control.

A specific object is to enable outer loop power control based on quality measurements other than BLER.

Another specific object is to enable outer loop power control for services with adaptation of the source coding rate.

Another specific object is to enable outer loop power control based on sub-block quality measurements.

Yet another specific object is to enable determination of an inner loop power control requirement based on sub-block quality measurements.

These and other objects are achieved in accordance with the attached claims.

Briefly, the present invention comprises collecting sub-block level quality measurements and adapting an inner loop requirement based at least on those measurements.

More specifically, the invention comprises collecting sub-block level quality measurements and mapping those to a block-level quality measure, and subsequently adapting the inner loop power control requirement based at least on a representation of the block-level quality measure.

Some of the advantages with the present invention are:
An outer loop power control that operates on quality rather than BLER
A quality model that can be updated on-line
An outer loop power control with fast convergence
Accurate quality estimate after one received block

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of power control in a communication system;

FIG. 2 is a schematic illustration of source coding rate adaptation;

FIG. 3 is a schematic flow diagram of an embodiment of a method according to the invention;

FIG. 4 is a schematic block diagram of an embodiment of an arrangement according to the invention;

FIG. 5 is a schematic block diagram of an embodiment of an arrangement according to the invention.

### DETAILED DESCRIPTION

Frequently mentioned abbreviations are listed below:
AMR Adaptive Multi-Rate. New speech coder used in GSM [1]
BER Bit Error-Rate. The number of erroneous bits divided by the total number of bits. The term rawBER means the BER at the input of the channel decoder.
BLEP BLock Error Probability. The probability that a single block is incorrect
BLER Block Error-Rate. The number of erroneous blocks divided by the total number of blocks.
EMR Enhanced Measurement Report. A new type of reporting scheme, where, the mobile reports the mean and standard deviation of the rawBER once every 480 ms. [4]
FER Frame Erasure Rate. The fraction of speech frames that were erased, i.e., discarded due to transmission errors.
SQI Speech Quality Index. An attempt to estimate the speech quality based on objective measurements, e.g. BER and BLER. [5]

In order to provide a clear and thorough understanding of the present invention, the problems with prior art will be discussed in detail below.

According to prior art, the power control is typically closed loop, which means that the system actually performs measurements that are affected by the power that the transmitting link uses.

With closed loop power control, the receiver measures some quantity of the received signal. It is important that this quantity is easy to measure, and that the measurement period is short, so that the transmit power can be frequently updated. The most common example of such a measurement is the Signal-to-Interference Ratio (SIR). This quantity may be measured very frequently. In WCDMA, SIR is measured 1500 times/second. The transmit power is adjusted so that the measured SIR is close to the so-called SIR target: if the measured SIR is higher than the SIR target, the transmit power is reduced, whereas the transmit power is increased if the measured SIR is lower than the target. In a stationary environment, this will force the SIR estimate to be equal to the SIR target.

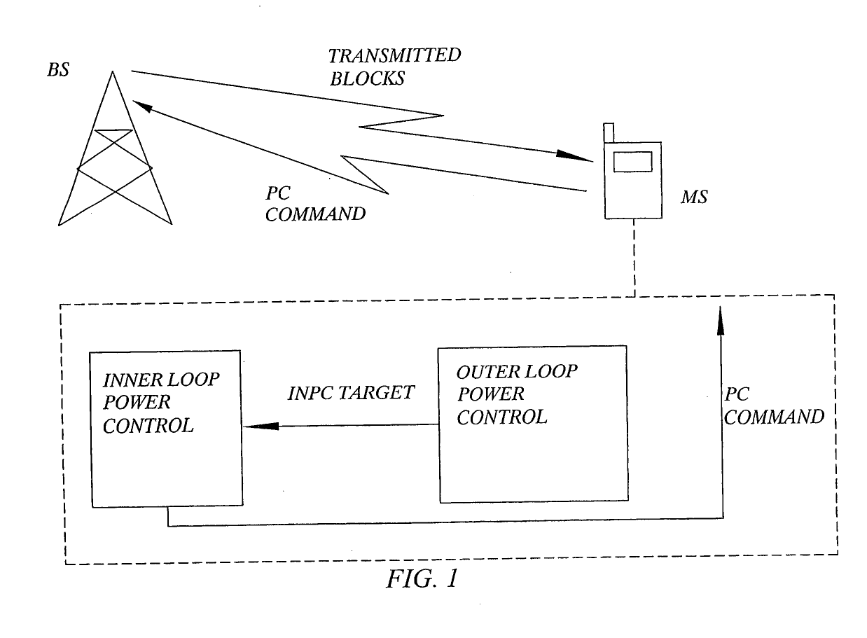

However, although the power control forces the SIR measurement to be equal to the SIR target, the received quality may not be sufficient. First, the SIR estimate may be inaccurate. Second, different receivers may require different SIR to achieve the same received quality, i.e. SIR may not be a very good quality measure. To overcome these two limitations, OLPC has been introduced in prior art, to complement the INPC. This is schematically illustrated in FIG. 1. The OLPC adjusts the target of the INPC to compensate for e.g. the two shortcomings mentioned above. The OLPC should operate on a quantity that is closely related to the actual received quality.

For the majority of services in interference limited communication systems, the service quality is closely related to the BLER i.e. the number of erroneous blocks divided by the total number of received blocks. Therefore, the OLPC, according to prior art, typically operates on the BLER, and each service is associated with a certain BLER target. In principle, the OLPC functionality increases the SIR target if the BLER exceeds the BLER target, and decreases the SIR target if the BLER is lower than the BLER target.

One problem with OLPC based on BLER, according to prior art, is that for some services the service quality is not directly related to the BLER. One important example of such a service is the so-called Adaptive Multi-Rate (AMR) [1] speech coder, recently introduced in commercial GSM systems.

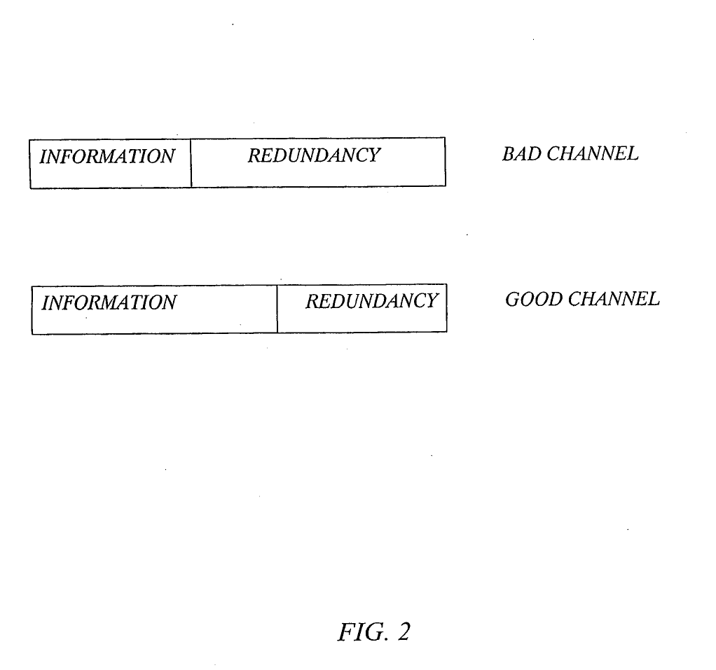

With AMR, the source and channel-coding rate is adapted to the channel quality. The speech-coding rate changes from 4.75 kbps with the MR475 mode to 12.2 kbps with the MR122 mode. When the channel quality is bad, a strong channel coder that adds a lot of redundancy is used, and when the channel quality is good, a weaker channel coder that adds only a small amount of redundancy is used. With the strong channel coding, successful transmission of the information bits becomes possible at worse channel conditions. Since the number of bits transmitted over the radio interface is fixed, the speech coder must adapt to deliver fewer bits. This principle is shown in FIG. 2.

Providing that all bits are received correctly, the speech quality is better the higher the speech-coding rate. However, the speech quality deteriorates when there are errors in the transmission. Therefore, a speech coder with lower rate where all the bits are received correctly may provide better speech quality than a high-rate speech coder with transmission errors. This is the reasoning behind AMR: it is better to “spend” the available bits on error protection, i.e. channel coding, if the channel is bad, than on more accurate speech coding i.e. a high speech coding rate.

A direct consequence of the adaptation of the speech coding rate is that the speech quality is not directly connected to the BLER anymore: the speech quality also depends on what speech coder was used for the transmission. In this case, a combination of the speech coding rate and BLER would provide a measure of the speech quality. Consequently, OLPC according to prior art cannot be used.

Even with fixed-rate speech coders, BLER may not be a good quality estimate. For instance, the speech quality is also affected by the distribution of block errors, an effect that has been included in the calculation of SQI [5]. In principle, it should be possible to design an OLPC that operates on SQI rather than directly on BLER.

Another problem with BLER is that for those BLER levels that are interesting in a cellular scenario (less than or equal to 1%) it takes a long time to get a good estimate of the BLER: the number of blocks required is in the order of 1/BLER.

In light of the above mentioned limitations, there is a need for improved power control, specifically improved outer loop power control, which can operate in situations where BLER is an inaccurate measure of quality, due to e.g. variations in the source coding rate.

The present invention overcomes these problems by providing an indirect estimate of a quantity that provides a measure of the service quality.

Digital information is normally transmitted in blocks. In this context, a block is the smallest unit that has a checksum attached to it to facilitate error detection. The information in a block is typically split into several sub-blocks before it is transmitted over the radio interface. In WCDMA, the sub-blocks are called slots, and in GSM they are called bursts.

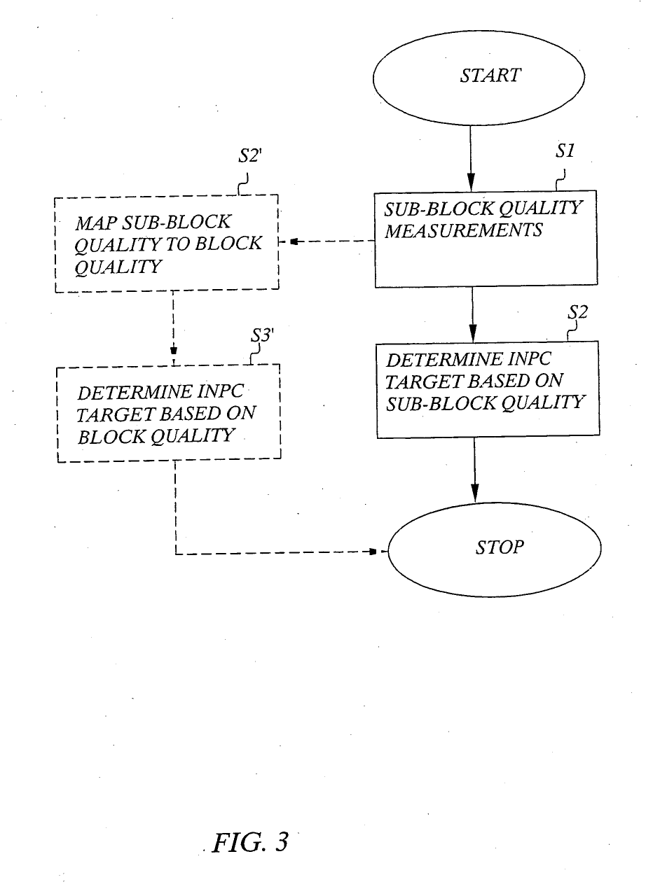

A basic embodiment, with reference to FIG. 3, of a method according to the invention comprises collecting S1 some quality measure, e.g. SIR, rawBER or mutual information of the received sub-blocks into which the block has been split. The concept of mutual information is described in [6]. Subsequently, the inner loop power control target or requirement is adjusted S2 based at least on the sub-block level quality measure or a representation thereof.

According to a more detailed embodiment, the collected sub-block level quality measure is mapped S2′ to a block level quality measure, e.g. SQI, BLEP, for each block. Subsequently, the inner loop power control target is adjusted S3′ based at least on the block level quality measure or a representation thereof.

Some exemplary mappings are discussed in [6]. Two examples of such mappings are given below:

1. In GSM, the rawBER can be estimated for every sub-block i.e. burst. A speech block is transmitted over eight consecutive bursts. Over these bursts, the mean and standard deviation of the rawBER can be calculated. With the introduction of the Enhanced Measurement Report (EMR) [4], these rawBER quantities become available both for uplink and downlink. Subsequently, the mean and the standard deviation of the rawBER are mapped to BLER or FER. Consequently, a two dimensional mapping is used for GSM i.e. two input values generate one output value. This model is described in some detail in [7].

2. In WCDMA, the SIR can be collected over the sub-blocks i.e. slots that are used to transmit a block. It has been shown that an exponential average of the SIR values form a good estimate of the link quality:

$${SIR}_{eff} = \frac{1}{C} ln ( \frac{{\sum }_{m = 1}^{N} exp ( - C {η}_{m} )}{N} )$$

where ln is the natural logarithm, ηₘ is the SIR of slot m and N is the number of sub-blocks within a coding block, and C is a service dependent constant that can be empirically determined with relative ease. SIR_{eff} can then either be used directly as a quality measure or mapped to BLER using data from a simulation.

The output of these models can be thought of as Block Level Error Probability (BLEP), which is an estimate of “instantaneous BLER”. The OLPC may then use BLEP instead of BLER. This means that already after one received block, the receiver will be able to estimate BLER with relatively good accuracy. Also, with AMR, it is possible to get an estimate of the BLEP that would be experienced if another speech coding mode were used, i.e. it is possible to estimate the quality of MR475 although MR122 is actually used, simply by using the right quality model.

The quality model can, according to one embodiment, be obtained by a link simulation, where the sub-block level quality measure is collected and grouped according to the chosen mapping, e.g. all blocks where the average and standard deviation of the rawBER falls into a specific interval are collected and the BLEP estimated from the fraction of erroneous blocks.

The quality model can, according to one embodiment, be updated on-line by using the same procedure: the sub-block-level quality measure is collected and mapped to the block-level quality measure. The status of the block (block error or not) is then checked and the result is used to update the quality model. Again taking the GSM mapping 1 as an example, for all received blocks with average rawBER and standard deviation of rawBER inside a predetermined interval, the total number of blocks and the number of erroneous blocks are counted. The quotient is then used as an estimate of the BLEP. If desired, different models can be automatically tuned for different terminal types. This would make sense for instance if the accuracy of the estimate of the sub-block level quality differs among different terminal types.

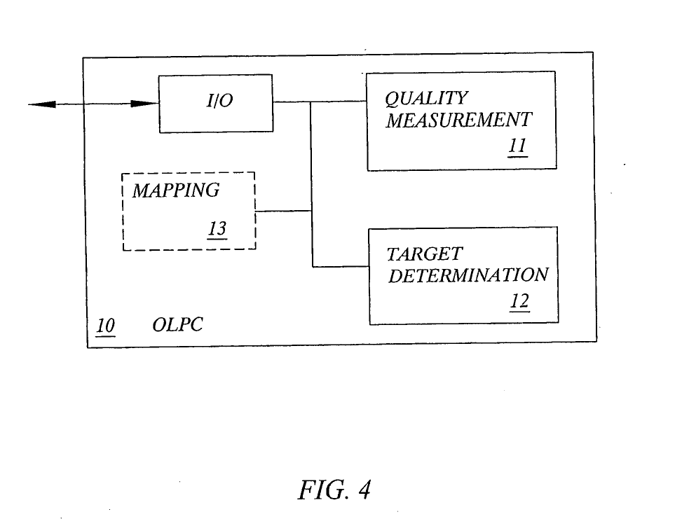

An embodiment of an arrangement according to the invention will be described below with reference to FIG. 4.

The arrangement 10 includes an I/O unit for receiving input signals and providing output signals to and from the arrangement, a unit for measuring and collecting quality measurements 11, a unit for determining an inner loop power control requirement or target 12.

The arrangement will be referred to as but not limited to an OLPC unit. The arrangement can equally be incorporated for providing an inner loop power control target in a more general power control arrangement.

According to the embodiment in FIG. 4, the quality measuring unit 11 is adapted to collect and/or measure some quality parameter or measurement for a plurality of sub-blocks within a received coding block. The quality measurement can comprise any one of rawBER, SIR, or mutual information or some other quantity.

The determining unit 12, according to the embodiment, is adapted to determine or adjust the inner loop power control target based on at least the sub-block level measurements or a representation thereof.

According to another specific embodiment, the arrangement 10 comprises a mapping unit 13 which is adapted to map the collected sub-block level quality measures to a corresponding block level quality measure. This is preferably performed by utilizing a predetermined quality model, as described previously. The determining unit 12 is then adapted to adjust or determine the inner loop power control requirement based on at least the block-level quality measurement or a representation thereof.

According to yet another specific embodiment, the mapping unit 13 is adapted to update the quality model based on which type of terminal is receiving the coding blocks, the type of source coder, etc.

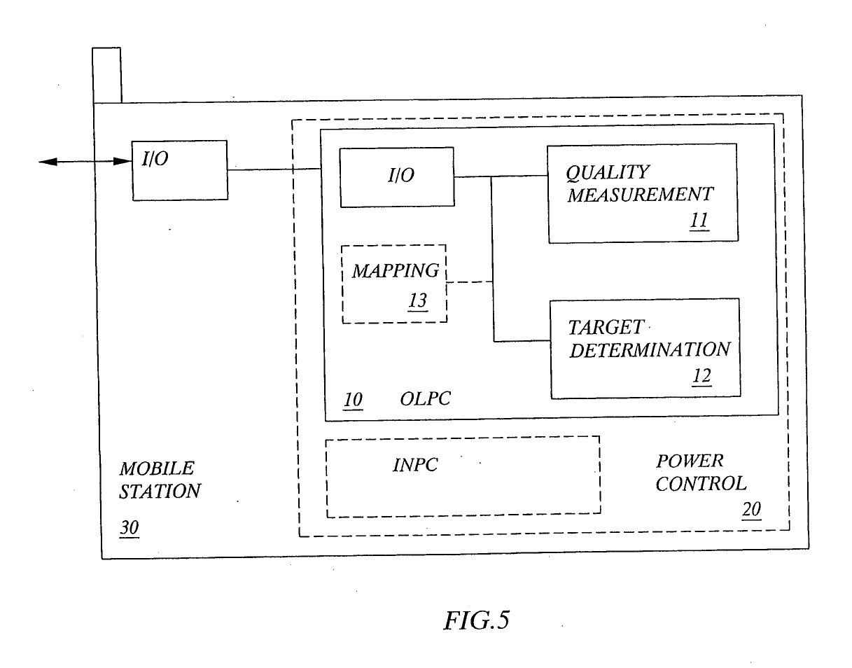

With reference to FIG. 5, an embodiment of a power control unit 20, according to the invention, comprises an inner loop power control unit INPC and an OLPC unit 10, in which said OLPC unit comprises a quality measurement unit 11, a target determining unit 12 and an optional mapping unit 13. The functionality of each unit is as described previously.

Also, with reference to FIG. 5, an embodiment of a mobile station 30, according to the invention, comprises a power control unit 20, according to the above embodiment.

Basically, the invention enables the OLPC to operate on an estimate of the instantaneous quality, which is estimated using sub-block level measurements. Thus, the invention makes it possible for the OLPC to adjust the INPC target based on a quality estimate other than BLER. The quality estimate could be the BLEP of the transmitted block. It could also be the BLEP that would be expected if another block were transmitted. It can also be some other quantity, such as SQI.

Some of the advantages of the present invention include:
OLPC with increased convergence rate
OLPC based on quality rather than BLER
Quality model which can be updated on-line.
Accurate quality estimate already after one received block.

It will be understood by those skilled in the art that various modifications and charges may be made to the present invention without departure from the scope thereof, which is defined by the appended claims.

### REFERENCES

[1] 3GPP, “Performance Characterization of the GSM Adaptive Multi-Rate (AMR) speech coder”, GSM 06.75, version 7.2.0, Release 1998
[2] “Power control in a CDMA mobile communication system”, WO01/20808 A3
[3] “Power control in a mobile radio communication system”, WO03/055098 A1
[4] 3GPP, “Radio subsystem link control”, TS 45.008, version 5.14.0, release 5
[5] Stefan Wanstedt et al., “Development of an objective speech quality measurement model for the AMR codec”, On-line workshop MESAQIN 2002.
[6] 3GPP2, “Effective-SNR Mapping for Modeling Frame Error Rates in Multiple-state Channels”, 3GPP2-C30-20030415, source Ericsson
[7] Håkan Olofsson et al., “Improved interface between Link Level and System Level Simulations Applied to GSM”, ICOPC'97, 1997

1. A method for improved outer loop power control in a communication system, characterized by:
collecting quality measurements for a plurality of sub-block within a received coding block; and
adjusting an inner loop power control requirement based at least on the collected sub-block level quality measurements.

2. The method according to claim 2, characterized by the further steps of:
collecting quality measurements for each of the plurality of sub-blocks within the received coding block;
mapping the collected sub-block level quality measurements to a block level quality measure;
adjusting the inner loop power control requirement based at least on a representation of the block level quality measure.

3. The method according to claim 1, characterized by said sub-block level quality measurements comprises estimates of one of, rawBER, SIR, or mutual information.

4. The method according to claim 2, characterized by mapping said sub-block level quality measurement to one of BLEP or SQI.

5. The method according to claim 2, characterized by mapping said sub-block level quality to said block-level quality utilizing a predetermined quality model.

6. The method according to claim 5, characterized by updating said quality model based on sub-block-level measurements over several received blocks.

7. The method according to claim 6, characterized by updating said quality model based on which type of terminal is receiving the blocks.

8. The method according to claim 6, characterized by updating said quality model based on which source-coding rate is used for the received blocks.

9. A device for outer loop power control in a communication system, characterized by:
means for collecting quality measurements for a plurality of sub-blocks within a received coding block; and
means for adjusting an inner loop power control requirement based at least on the collected sub-block level quality measurements.

10. The device according to claim 9, characterized by said device further comprising:
means for mapping the collected sub-block level quality measurements to a block level quality measure; and
said adjusting means are adapted for adjusting the inner loop power control requirement based at least on a representation of the block level quality measure.

11. The device according to claim 9, characterized in that said collecting means are adapted for collecting sub-block level quality measurements comprising estimates of one of rawBER, SIR, or mutual information.

12. The device according to claim 10, characterized in that said mapping means are adapted for mapping said sub-block level quality to said block-level quality utilizing a predetermined quality model.

13. The device according to claim 10, characterized in that said block level quality measure comprises one of BLEP or SQI.

14. The device according to claim 12, characterized in that said mapping means are adapted for updating the predetermined quality model based on sub-block-level measurements over several received blocks.

15. The device according to claim 12, characterized in that said mapping means are adapted for updating the predetermined quality model based on the type of terminal that is receiving the blocks.

16. The device according to claim 12, characterized in that said mapping means are adapted for updating the predetermined quality model based on which source-coding rate is used for the received blocks.

17. A power control unit in a communication system, characterized by a device for outer loop power control according to claim 9.

18. A mobile terminal, characterized by a power control unit according to claim 17.
